(19) United States
(12) Patent Application Publication
(10) Pub. No.: US 2013/0035851 A1
(43) Pub. Date: Feb. 7, 2013

(54) NAVIGATOR

(71) Applicant: Hua-En ZHANG, Shanghai (CN)

(72) Inventor: Hua-En ZHANG, Shanghai (CN)

(21) Appl. No.: 13/222,304

(22) Filed: Aug. 31, 2011

(30) Foreign Application Priority Data
Aug. 1, 2011 (CN) 201110218609.2

(51) Int. Cl. G01C 21/00

(52) U.S. Cl. 701/426; 701/438

(57) ABSTRACT

The present invention discloses a navigator. The navigator comprises a control unit connecting to a storage unit and a positioning unit. The storage unit stores a plurality of map information. The plurality of map information comprises a plurality of points of interest (POIs). The positioning unit provides the position information. First, the control unit gets the number of the plurality of points of interest in the location of the navigator according to the position information and the plurality of map information. Then, the control unit controls a display unit to show a display scale around maps of the navigator according to the number of the plurality of points of interest and a number threshold value.

### BACKGROUND OF THE INVENTION

1. Field of the Invention

The exemplary embodiment(s) of the present invention relates to a field of navigator. More specifically, the exemplary embodiment(s) of the present invention relates to a navigator that could adjust the display range of the map according to the rank and quantity of the point of interest (POI).

2. Description of Related Art

The conventional navigating system provides the navigating service for vehicles according to the real-time position signal transmitted by the GPS system and the navigating software which has loaded the map information. Usually, the position of the vehicle is set as a starting position, and a target position inputted by the users would be provided along with the starting position to the vehicle navigating system, for calculating the shortest path from the starting position to the target position and providing the path to the user.

A convenient characteristic of the navigating system is that the point of interest (POI) of the designated position could be listed. Though the navigators on the market have the functions of adjusting the display range of the map according to the car speed or the rank of the road, there is no navigator having functions of adjusting the display range of the map according to the rank and quantity of the POI. Thus, though the POIs (including less important POIs) are displayed on the screen, the display range of the map still could not be adjusted under this situation, and cause the displayed frame too complicated to be easily understood by the user. Therefore, the inventors of the present invention has thought and developed a navigator to solve the problems mentioned above, and further increase the industry implementation.

### SUMMARY OF THE INVENTION

To solve the problems in the conventional arts, it is a primary object of the present invention to provide a navigator to solve the problem that the conventional navigator does not have the function of adjusting the display range of the map according to the rank and quantity of the POI.

To achieve the above object, a navigator according to the present invention is disclosed, which comprises a storing unit, a positioning unit and a control unit. The storing unit stores map data including a plurality of points of interest (POI), and the positioning unit provides position data. The control unit electronically connects to the storing unit and the positioning unit, and obtains the quantity of the POI around the position of the navigator according to the map data and the position data. The control unit further controls a display unit to adjust the display range of the map adjacent to the position of the navigator according to the quantity of the POI and a quantity threshold value.

To achieve another object, a navigator according to the present invention is disclosed, which comprises a storing unit, a positioning unit, and a control unit. The storing unit stores map data including a plurality of points of interest (POIs), and the POIs are divided into a plurality of ranks. The positioning unit provides position data. The control unit electronically connects to the storing unit and the positioning unit, and obtains the ranks of the POIs around the position of the navigator according to the map data and the position data. The control unit further controls a display unit to adjust the display range of the map adjacent to the position of the navigator according to the ranks of the POIs and a rank threshold value.

To achieve the above object, still another navigator according to the present invention is disclosed, which comprises a storing unit, a positioning unit, and a control unit. The storing unit stores map data including a plurality of points of interest (POIs), and the POIs are divided into a plurality of ranks. The positioning unit provides position data. The control unit electronically connects to the storing unit and the positioning unit, and obtains the ranks and the quantity of the POIs around the position of the navigator according to the map data and the position data. The control unit further controls a display unit to adjust the display range of the map adjacent to the position of the navigator according to the ranks of the POIs, the quantity of the POIs, a quantity threshold value and a rank threshold value.

With the above arrangement, the navigator of the present invention automatically adjusts the display range according to the ranks and the quantity of the POIs to increase the clarity and the convenience when browsing.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a block diagram of the first embodiment of the navigator in accordance with the present invention;

FIG. 2 illustrates a schematic diagram of the first embodiment of the navigator in accordance with the present invention;

FIG. 3 illustrates another schematic diagram of the first embodiment of the navigator in accordance with the present invention;

FIG. 4 illustrates a block diagram of the second embodiment of the navigator in accordance with the present invention;

FIG. 5 illustrates a schematic diagram of the second embodiment of the navigator in accordance with the present invention;

FIG. 6 illustrates another schematic diagram of the second embodiment of the navigator in accordance with the present invention;

FIG. 7 illustrates a block diagram of the third embodiment of the navigator in accordance with the present invention;

FIG. 8 illustrates the first schematic diagram of the third embodiment of the navigator in accordance with the present invention;

FIG. 9 illustrates the second schematic diagram of the third embodiment of the navigator in accordance with the present invention;

FIG. 10 illustrates the third schematic diagram of the third embodiment of the navigator in accordance with the present invention;

FIG. 11 illustrates the forth schematic diagram of the third embodiment of the navigator in accordance with the present invention;

FIG. 12 illustrates a flow chart of the first embodiment of the control method of the navigator in accordance with the present invention;

FIG. 13 illustrates a flow chart of the second embodiment of the control method of the navigator in accordance with the present invention;

FIG. 14 illustrates a flow chart of the third embodiment of the control method of the navigator in accordance with the present invention; and

FIG. 15 illustrates another flow chart of the third embodiment of the control method of the navigator in accordance with the present invention.

### DETAILED DESCRIPTION OF THE PREFERRED EMBODIMENTS

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

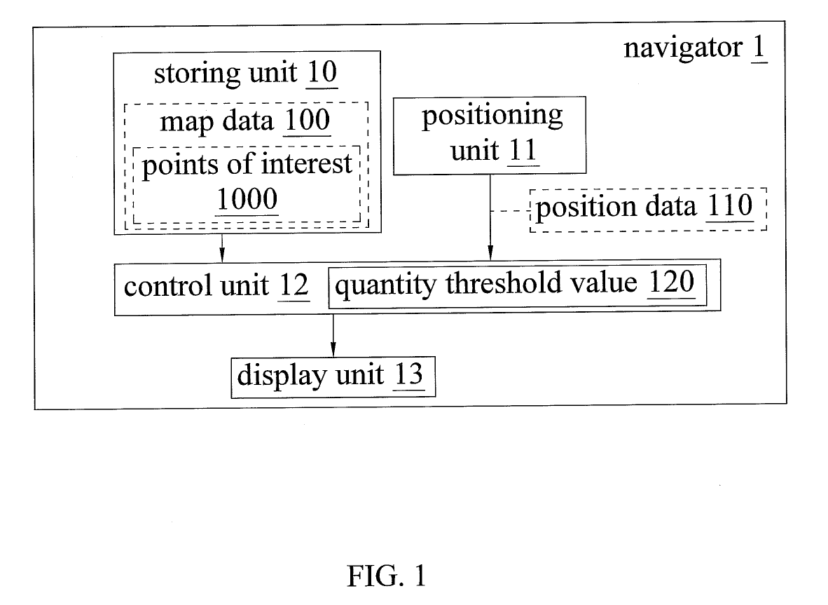

Please refer to FIG. 1, which illustrates a block diagram of the first embodiment of the navigator in accordance with the present invention. As shown in this figure, the navigator 1 according to the present invention comprises a storing unit 10, a positioning unit 11, a control unit 12, and a display unit 13, wherein the control unit 12 connects to the storing unit 10, the positioning unit 11 and the display unit 13.

The storing unit 10 could be many kinds of storing media such as embedded memory device, external memory, magnetic disk or compact disk, and the storing unit 10 stores a plurality of map data 100 including a plurality of points of interest (POI) 1000, wherein the POI could be but not limited to a school, a restaurant, a hospital, an exhibition hall, a company or an user-defined new scenic spot.

The positioning unit 11 positions the navigator 1 and correspondingly provides position data 110. In some preferred embodiments, the positioning unit 11 could be a global positioning system (GPS), which calculates the position of the positioning unit 11 and correspondingly provides position data 110 after receiving satellite signals. When the control unit 12 receives the position data 110 from the positioning unit 11, the control unit 12 searches the storing unit 10 to find the corresponding map data 100 according to the position data 110, and calculates the quantity of the POI 1000 around the position of the navigator 1 according to the position data 100 and the map data 100. The control unit 12 has a quantity threshold value 120, and the control unit 12 controls a display unit 13 to adjust the display range of the map adjacent to the position of the navigator 1 according to the quantity of the POI 1000 around the position of the navigator 1 and the quantity threshold value 120.

In some preferred embodiment, when the quantity of the POI 1000 around the position of the navigator 1 is greater than the quantity threshold value 120, the control unit 12 controls the display unit 13 to reduce the display range of the map adjacent to the position of the navigator 1 to avoid the problem of inconvenience in browsing caused by too many POIs on the map. On the other hand, when the quantity of the POI 1000 around the position of the navigator 1 is lower than the quantity threshold value 120, the control unit 12 controls the display unit 13 to enlarge the display range of the map adjacent to the position of the navigator 1 to provide more POIs for the user.

What is deserved to be mentioned is that the navigator 1 could be any kind of electronic apparatus which could display electronic map and a plurality of POIs, such as notebook, cell phone and PDA. According to the present invention of the navigator, the user could easily use these electronic apparatuses to adjust the display range based on the environment.

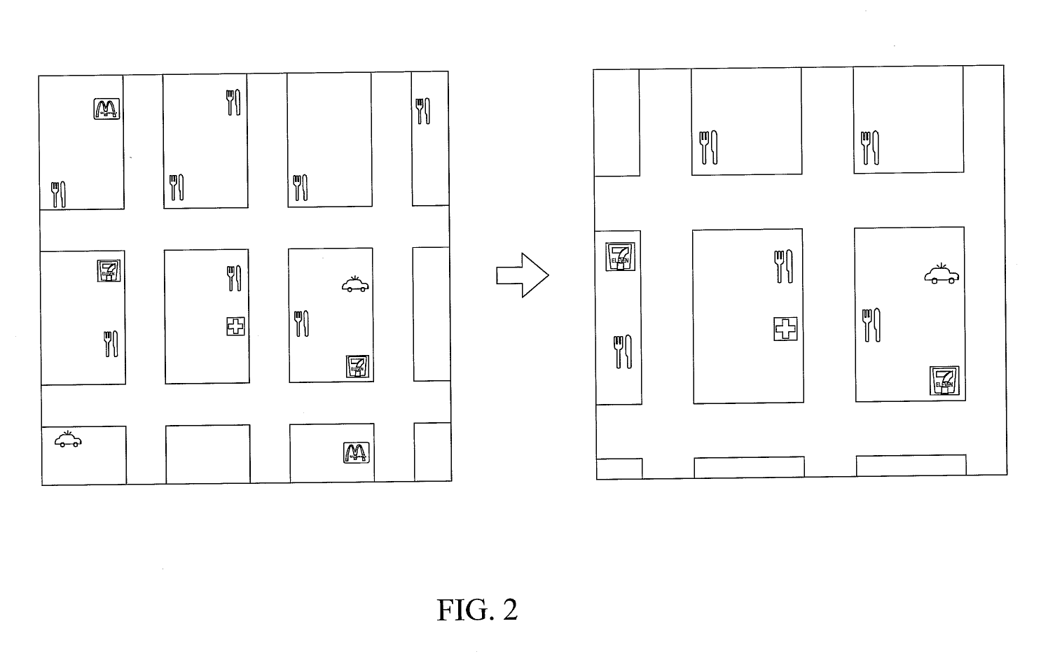

Please refer to FIG. 2, which illustrates a schematic diagram of the first embodiment of the navigator in accordance with the present invention. In the present embodiment, the quantity threshold value is set to be 10. What is deserved to be mentioned is that the quantity threshold value could be built-in or user-defined. When a user set up a value, the navigator 1 provides the user an interface to enter the value to be the basis of the quantity threshold value.

As shown in FIG. 2, the quantity of the POI around the position of the navigator 1 is 15 and is greater than the quantity threshold value which is 10, so the control unit reduces the display range of the map adjacent to the position of the navigator 1 to let the user brows an enlarged map and avoid the problem that too many POIs cause the frame being too complicated to be easily understood.

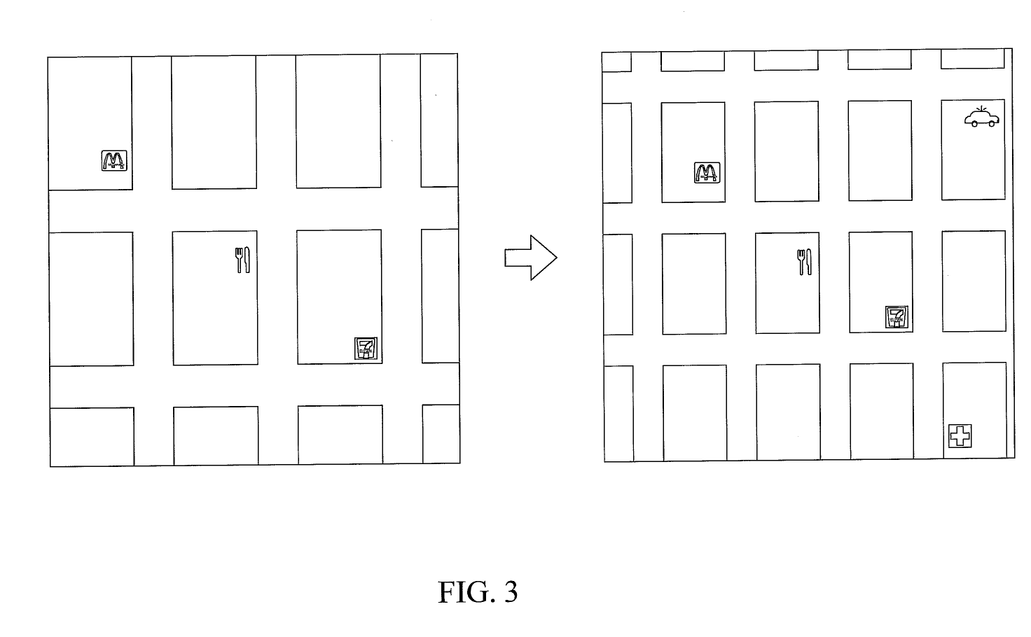

Please refer to FIG. 3, which illustrates another schematic diagram of the first embodiment of the navigator in accordance with the present invention. In the present embodiment, the quantity threshold value is set to be 6. As shown in this figure, the quantity of the POI around the position of the navigator 1 is 3 and is lower than the quantity threshold value which is 6, so the control unit enlarges the display range of the map adjacent to the position of the navigator 1 to display more POIs on the map adjacent to the position of the navigator 1 and increase convenience when browsing more POIs.

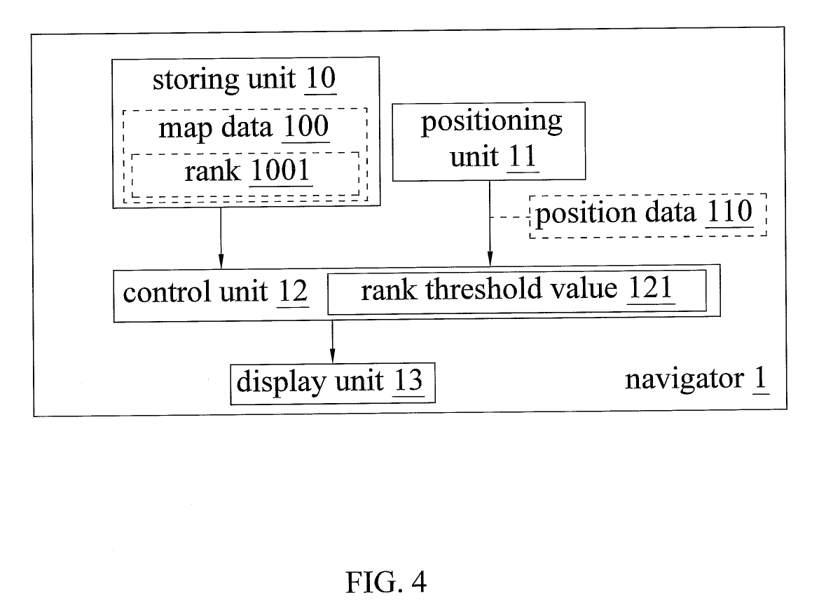

Please refer to FIG. 4, which illustrates a block diagram of the second embodiment of the navigator in accordance with the present invention. As shown in this figure, the framework of the second embodiment is almost the same with the first embodiment. The differences between the first embodiment and the second embodiment are: a plurality of points of interest (POIs) 1000 in the storing unit 10 could further be divided into a plurality of ranks 1001, such as to the rank of hospital, school and airport is higher than convenient stores or chain stores (not limited to the example but decided by the user); the control unit 12 has a rank threshold value 121, and the control unit 12 controls the display unit 13 to adjust the display range of the map adjacent to the position of the navigator according to the quantity of the POIs 1000 and the rank threshold value 121.

In some preferred embodiments, in order to let the user knows the direction of the POI on the map, the control unit 12 controls the display unit 13 to reduce the display range of the map adjacent to the position of the navigator 1 when the rank 1001 of the POI 1000 is lower than the rank threshold value 121. On the other hand, in order to highlight the POI with lower rank, the control unit 12 controls the display unit 13 to enlarge the display range of the map adjacent to the position of the navigator when the rank of the POI is higher than the rank threshold value.

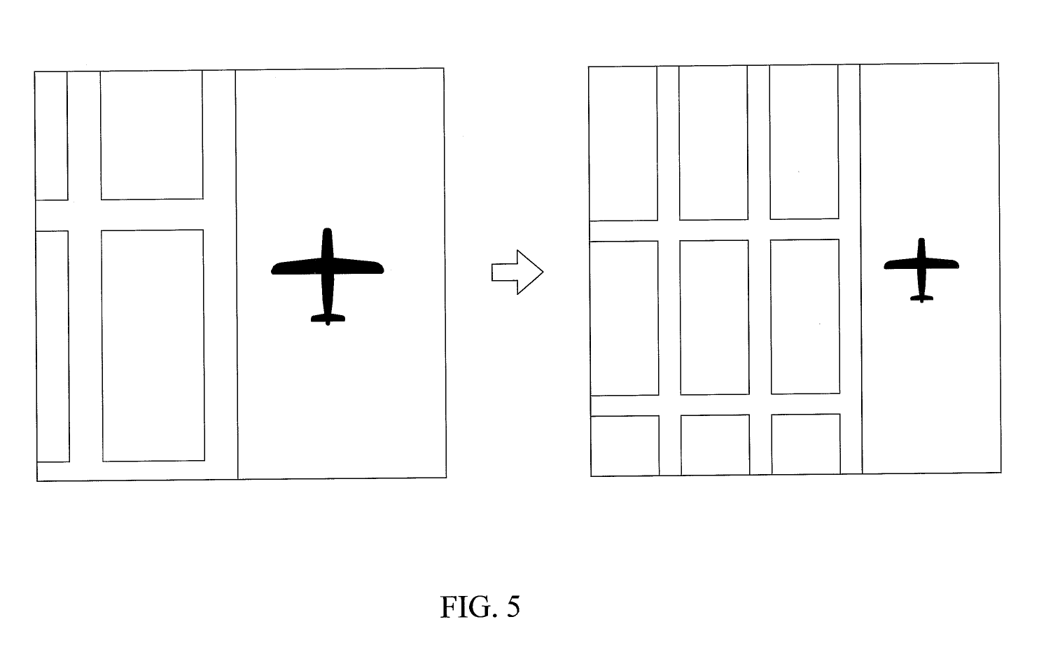

Please refer to FIG. 5, which illustrates a schematic diagram of the second embodiment of the navigator in accordance with the present invention. In the present embodiment, a plurality of POIs are divided into 3 ranks shown as below:

| Rank | Type |
|---|---|
| 1 | Restaurant, Chain stores, Gas station and Convenient stores |
| 2 | Scenic sites and Museum |
| 3 | Airport, Hospital and First-aid stations |

Wherein, the rank threshold value is set to be 2. What is deserved to be mentioned is that the rank threshold value could be built-in or user-defined. When a user wants to set up a rank threshold value, the navigator 1 would provide the user an interface to enter the value to be the basis of the rank threshold value.

As shown in FIG. 5, an airport is marked on the map. The rank of the airport is 3 and is higher than the rank threshold value which is 2, so the navigator 1 increases the display range of the map adjacent to the position of the navigator 1 to let users know the direction of the airport on the map.

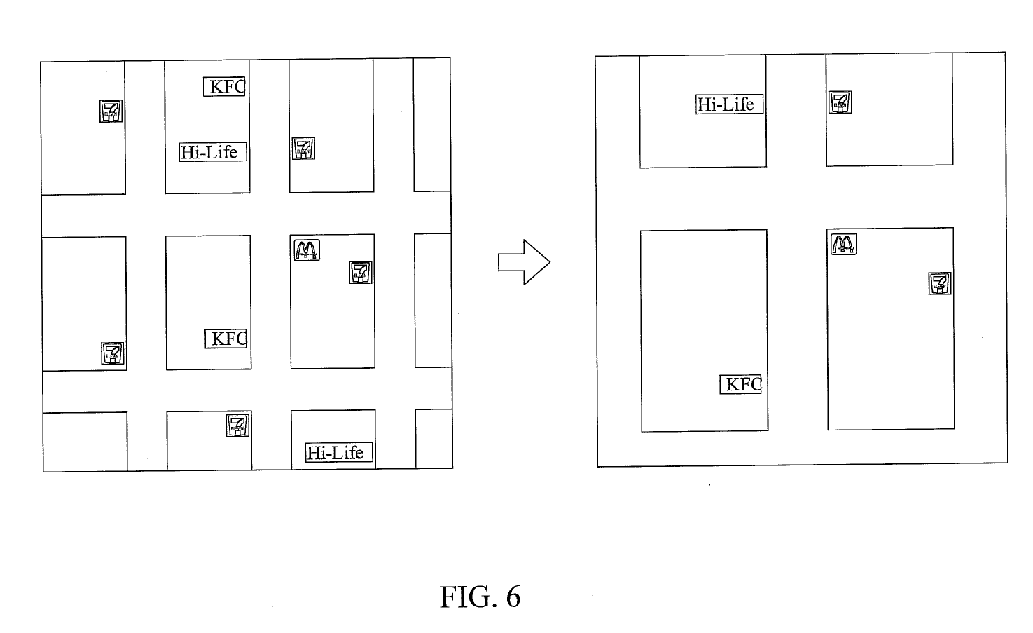

Please refer to FIG. 6, which illustrates another schematic diagram of the second embodiment of the navigator in accordance with the present invention. In the present embodiment, the rank threshold value is set to be 2. As shown in this figure, all POIs belong to the type of restaurant or convenient stores, and the average rank of all POIs is 1 and is lower then rank threshold value which is 2, thus the navigator 1 reduces the display range of the map adjacent to the position of the navigator 1 to highlight the POIs with lower rank.

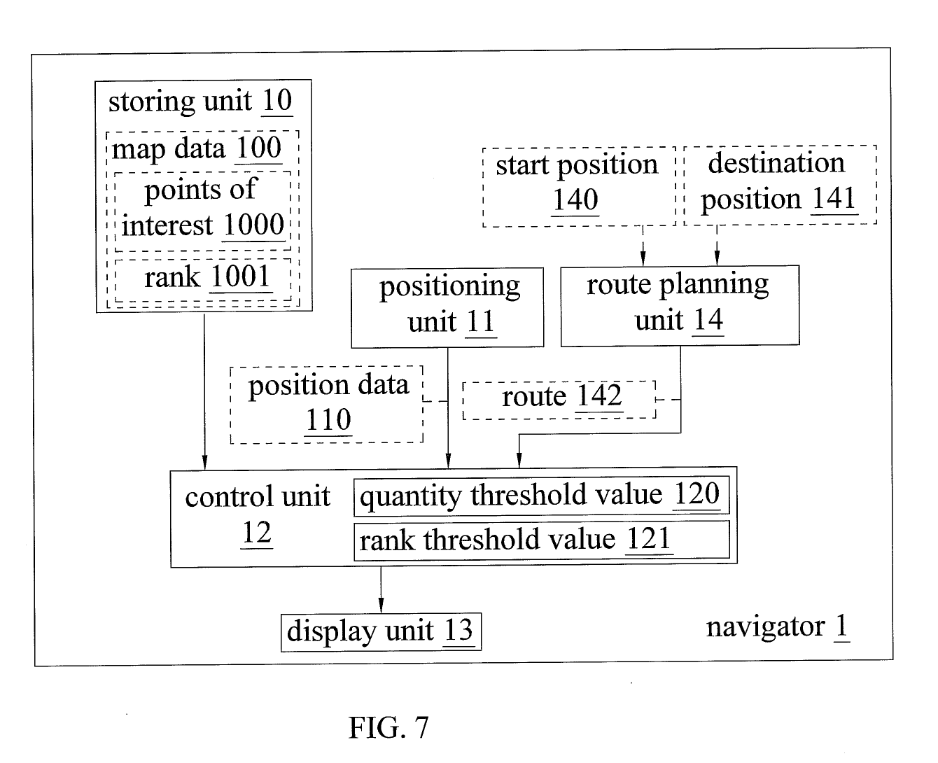

Please refer to FIG. 7, which illustrates a block diagram of the third embodiment of the navigator in accordance with the present invention. As shown in this figure, the framework is almost the same with the first embodiment and the second embodiment. The difference is the present embodiment combines the first embodiment and the second embodiment. In other words, the control unit 12 has a quantity threshold value 120 and a rank threshold value 121. The control unit 12 controls a display unit 13 to adjust the display range of the map adjacent to the position of the navigator 1 according to the quantity of the POIs 1000, the ranks of the POIs 1001, the quantity threshold value 120 and the rank threshold value 121.

Besides, the navigator 1 in accordance with the present invention further comprises a route planning unit 14. The route planning unit 14 generates a route 142 according to a start position 140, a destination position 141 and the map data 100. The route planning unit 14 and the positioning unit 11 could separately be an independent processing chip, or they could also be combined with the control unit 12 as one processing chip. The display unit 13 could be many kinds of display apparatus, such as a liquid crystal display, a projector, an organic light emitting diode display or an e-paper, and the display unit 13 displays the route 142 and a plurality of POIs 1000. In some preferred embodiments, the control unit 12 calculates the quantity of the POIs 1000 and the ranks of the POIs 1001 around the position of the navigator 1 according to the map data 100 and the position data 110, and the control unit further calculates an average rank of the POIs 1000. The control unit 12 controls the display unit 13 to adjust the display range of the map adjacent to the position of the navigator 1 according to the quantity of the POIs 1000, the average rank, the quantity threshold value 120 and the rank threshold value 121.

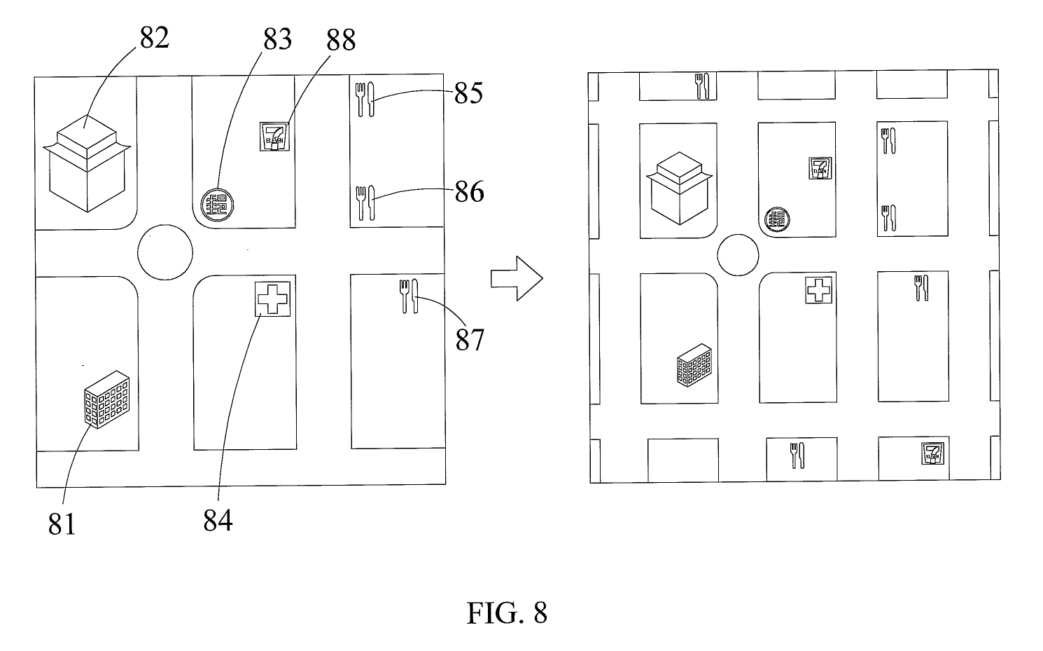

Please refer to FIG. 8, which illustrates the first schematic diagram of the third embodiment of the navigator in accordance with the present invention. In the present embodiment, a plurality of POIs is divided into 4 ranks (not restricted to 4) shown as below:

| Rank | Type |
|---|---|
| 1 | Bookstores, Restaurant, Chain stores, Gas station and |
| | Convenient stores |
| 2 | Scenic sites and Museum |
| 3 | Post Office, Public Center, Local Station |
| 4 | Central Station, Airport, Hospital, First-aid stations |
| | and the workplace |

What is deserved to be noticed is that the user could set his/her workplace in any rank. In the present embodiment, the user sets the rank of the workplace as 4. Wherein the rank threshold value is 2 and the quantity threshold value is 7, and the quantity threshold value and the rank threshold value could be built-in in the navigator 1 or user-defined.

As shown in FIG. 8, the quantity of the POIs is 8 higher than the quantity threshold value which is 7. Besides, the POI 81 is the workplace and the rank is 4; the POI 82 is Taipei Main Station belongs to central station type so the rank is 4; the POI 83 is a post office so and the rank is 3; the POI 84 is a hospital and the rank is 4; the POI 85˜87 are restaurant and the rank is 1; the POI 88 is a convenient store and the rank is 1. The average rank of all POIs is 2.375 and is higher than the value threshold value. In the present embodiment, the control unit controls the display unit to enlarge the display range of the map adjacent to the position of the navigator when the quantity of the POI is higher than the quantity threshold value and the rank of the POI is higher than the rank threshold value as described above.

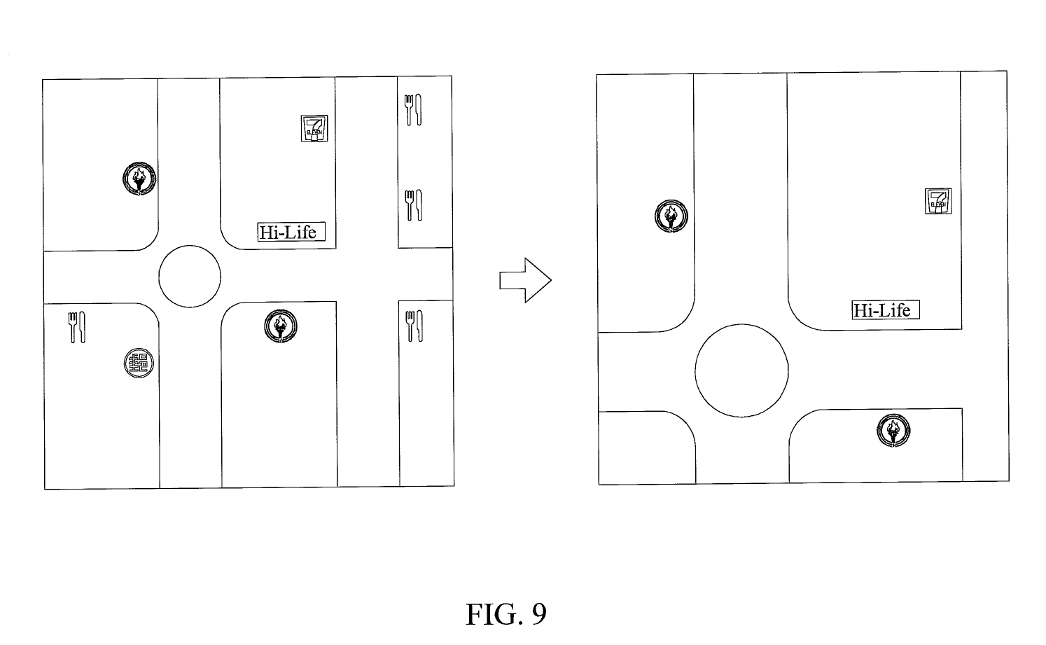

Please refer to FIG. 9, which illustrates the second schematic diagram of the third embodiment of the navigator in accordance with the present invention. In this figure, the framework is almost the same with the first schematic diagram. The difference between them is that the quantity of the POIs is 9 and is higher than the quantity threshold value which is 7. Besides, most types of the POIs are those with lower rank such as restaurants, gas stations or convenient stores, and only one post office with rank 3. The average rank of all POIs is 1.2 and is lower than the rank threshold value which is 2. In the present embodiment, the control unit controls the display unit to reduce the display range of the map adjacent to the position of the navigator when the quantity of the POI is higher than the quantity threshold value and the rank of the POI is lower than the rank threshold value.

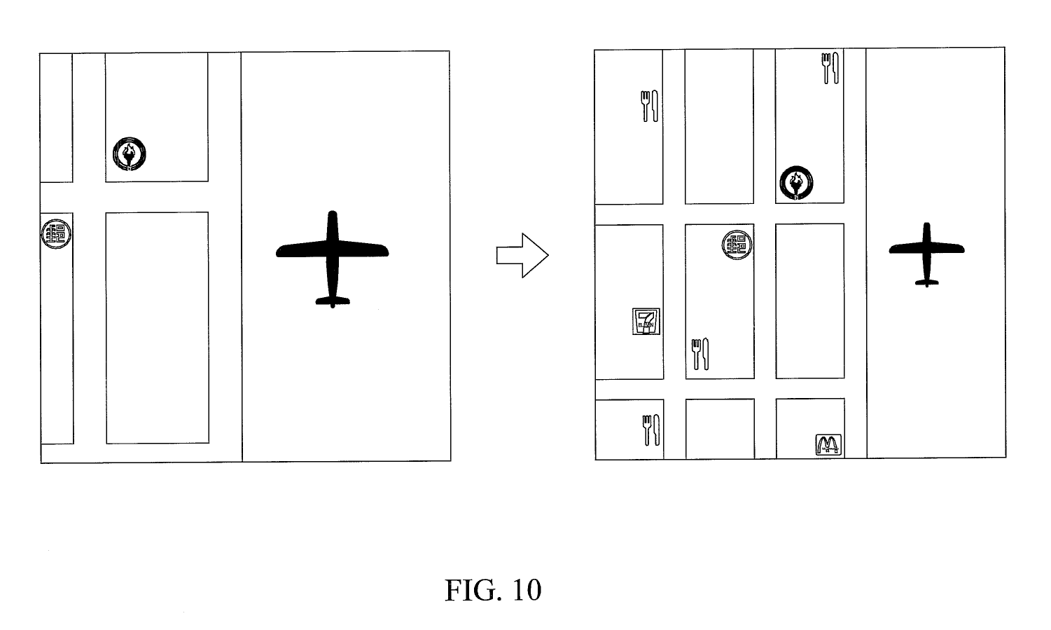

Please refer to FIG. 10, which illustrates the third schematic diagram of the third embodiment of the navigator in accordance with the present invention. In this figure, the framework is almost the same with the first schematic diagram. The difference between them is that the quantity of the POIs is 3 and is lower than the quantity threshold value which is 7. Besides, most types of the POIs are those with higher rank such as the airport and the post office, and only one gas station with rank 1. The average rank of all POIs is 2.67 and is higher than the rank threshold value. In the present embodiment, the control unit controls the display unit to enlarge the display range of the map adjacent to the position of the navigator though the quantity of the POI is lower than the quantity threshold value and the rank of the POI is higher than the rank threshold value.

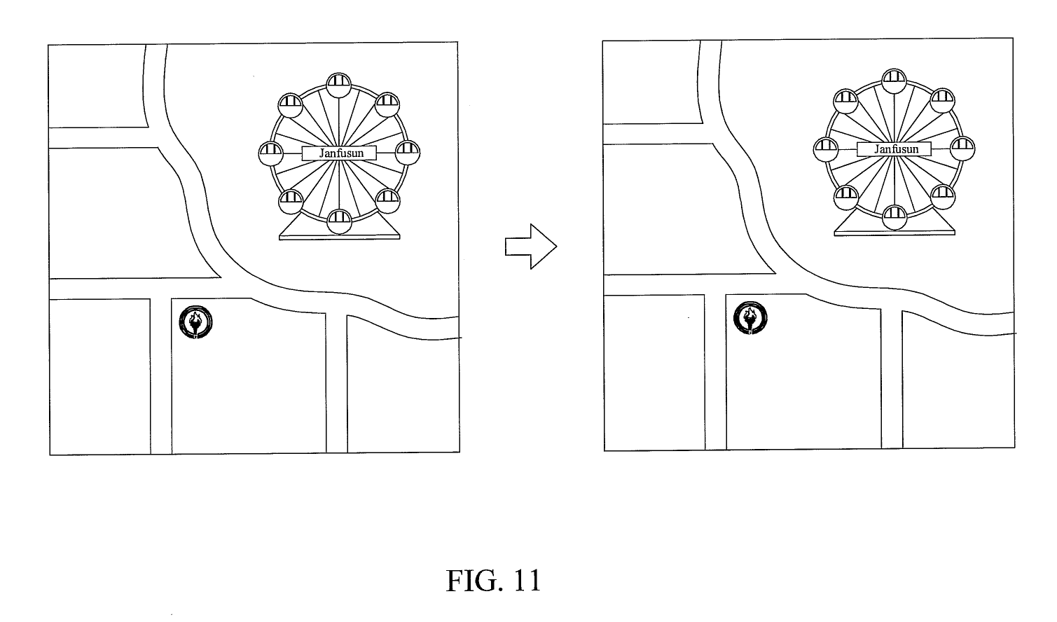

Please refer to FIG. 11, which illustrates the forth schematic diagram of the third embodiment of the navigator in accordance with the present invention. In this figure, the framework is almost the same with the first schematic diagram. The difference between them is that the quantity of the POIs is 2 and is lower than the quantity threshold value which is 7. Besides, most types of the POIs are those with lower rank such as the gas station and scenic sites. The average rank of all POIs is 1.5 and is lower than the rank threshold value. In the present embodiment, the control unit controls the display unit to maintain the display range of the map adjacent to the position of the navigator when the quantity of the POI is lower than the quantity threshold value and the rank of the POI is lower than the quantity threshold value.

In the embodiments described above show the example of how the control unit adjusts the display range of the map adjacent to the position of the navigator such as to enlarge, reduce or maintain the display range according to many kinds of situations to illustrate the concept of the present invention. Those of ordinary skilled in the art could easily understand and change any kind of situation to control the display range. All depend on the user's setup.

Although the concept of the control method of the navigator according to the present invention has been described when illustrating the navigator according to the present invention above, in order to get clearer, a flow chart is further drawing below.

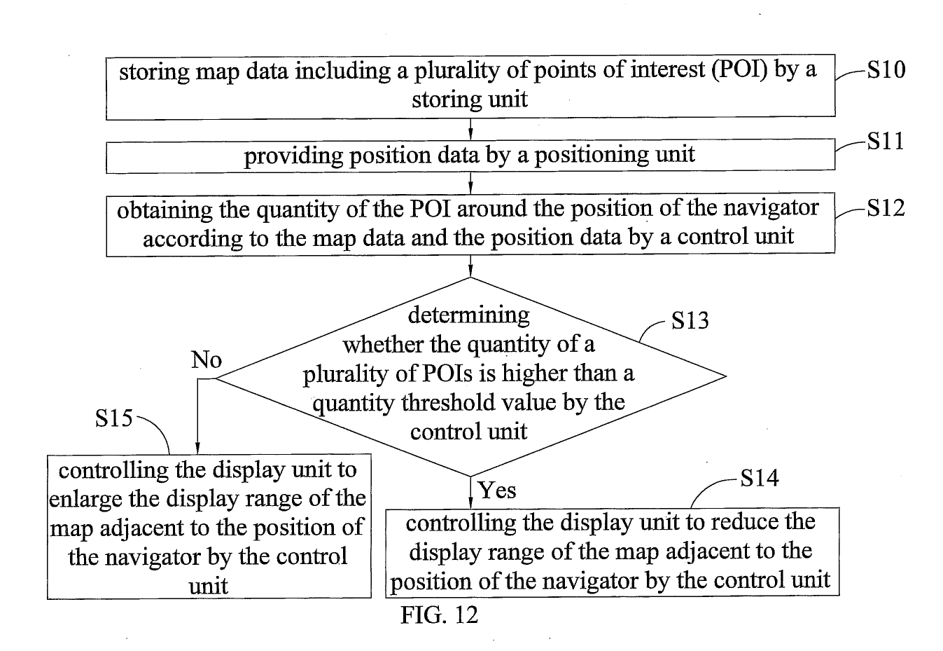

Please refer to FIG. 12, which illustrates a flow chart of the first embodiment of the control method of the navigator in accordance with the present invention. As shown in FIG. 12, the control method of the navigator in accordance with the present invention comprises the following steps of:

(S10) storing map data including a plurality of points of interest (POI) by a storing unit;
(S11) providing position data by a positioning unit;
(S12) obtaining the quantity of the POI around the position of the navigator according to the map data and the position data by a control unit;
(S13) determining whether the quantity of a plurality of POIs is higher than a quantity threshold value by the control unit;
If the quantity of a plurality of POIs is higher than a quantity threshold value, go to (S14). Otherwise, go to (S15);
(S14) controlling the display unit to reduce the display range of the map adjacent to the position of the navigator by the control unit; and
(S15) controlling the display unit to enlarge the display range of the map adjacent to the position of the navigator by the control unit;

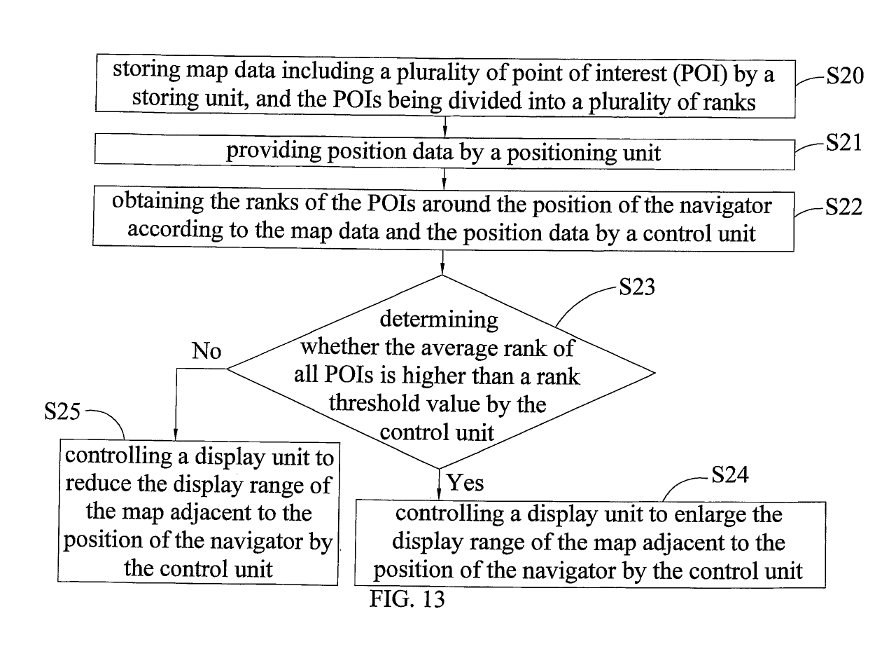

Please refer to FIG. 13, which illustrates a flow chart of the second embodiment of the control method of the navigator in accordance with the present invention. As shown in FIG. 13, the control method of the navigator in accordance with the present invention comprises the following steps of:

(S20) storing map data including a plurality of points of interest (POIs) by a storing unit, and the POIs being divided into a plurality of ranks;
(S21) providing position data by a positioning unit;
(S22) obtaining the ranks of the POIs around the position of the navigator according to the map data and the position data by a control unit;
(S23) determining whether the average rank of all POIs is higher than a rank threshold value by the control unit;
If the average rank of all POIs is higher than a rank threshold value, go to (S24); Otherwise, go to (S25);
(S24) controlling a display unit to enlarge the display range of the map adjacent to the position of the navigator by the control unit; and
(S25) controlling a display unit to reduce the display range of the map adjacent to the position of the navigator by the control unit.

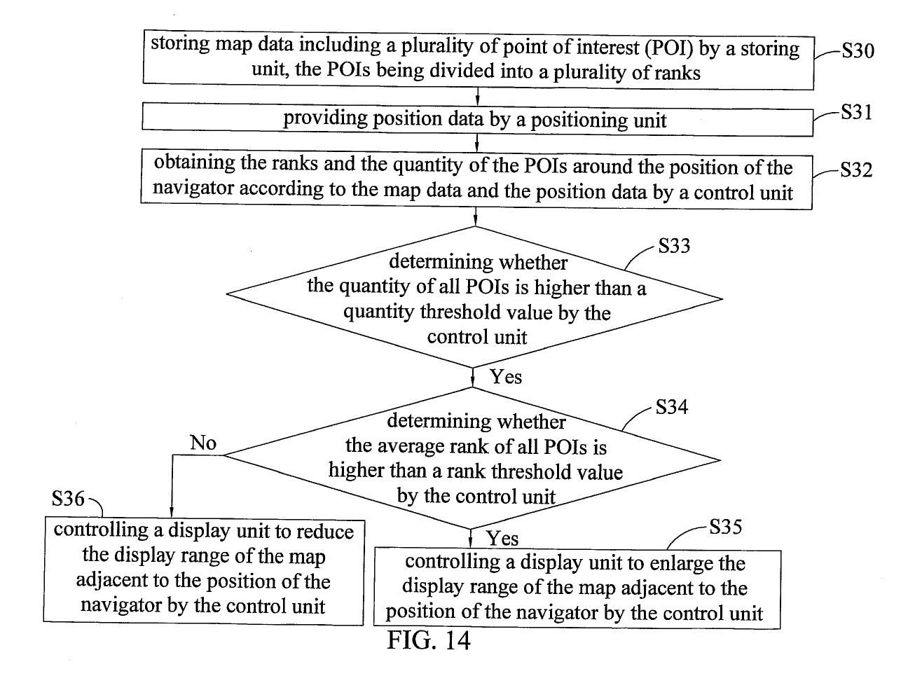

Please refer to FIG. 14, which illustrates a flow chart of the third embodiment of the control method of the navigator in accordance with the present invention. As shown in FIG. 14, the control method of the navigator in accordance with the present invention comprises the following steps of:

(S30) storing map data including a plurality of points of interest (POIs) by a storing unit, the POIs being divided into a plurality of ranks;
(S31) providing position data by a positioning unit;
(S32) obtaining the ranks and the quantity of the POIs around the position of the navigator according to the map data and the position data by a control unit;
(S33) determining whether the quantity of all POIs is higher than a quantity threshold value by the control unit;
If the quantity of all POIs is higher than a quantity threshold value, go to (S34);
(S34) determining whether the average rank of all POIs is higher than a rank threshold value by the control unit;
If the average rank of all POIs is higher than a rank threshold value, go to (S35); Otherwise, go to (S36);
(S35) controlling a display unit to enlarge the display range of the map adjacent to the position of the navigator by the control unit; and
(S36) controlling a display unit to reduce the display range of the map adjacent to the position of the navigator by the control unit.
Wherein, the step (S33) could be executed before the step (S24). The priority of execution is not restricted in the present invention.

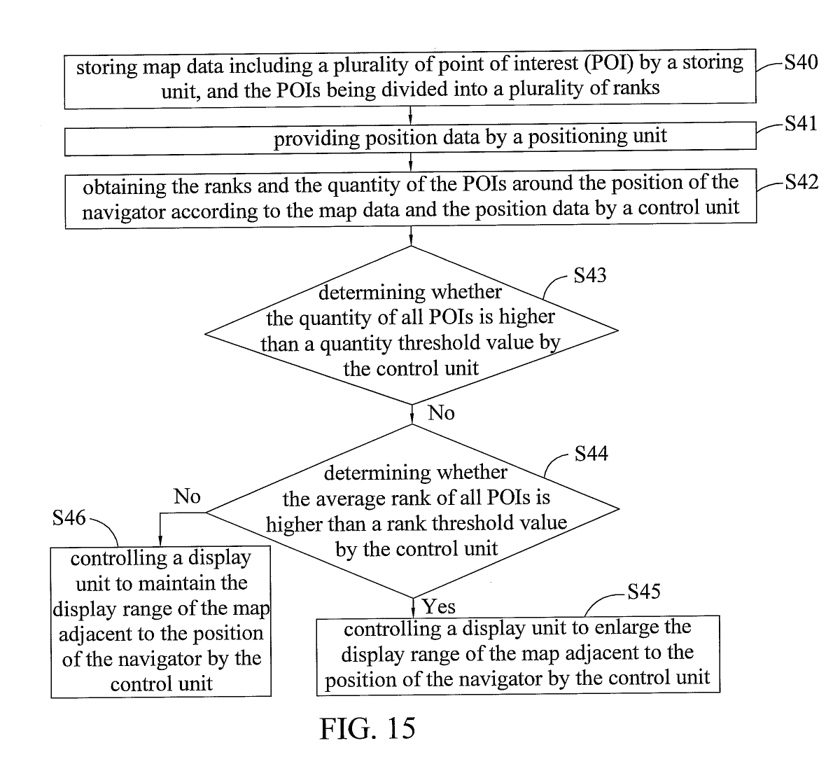

Please refer to FIG. 15, which illustrates another flow chart of the second embodiment of the control method of the navigator in accordance with the present invention. As shown in FIG. 15, the control method of the navigator in accordance with the present invention comprises the following steps of:

(S40) storing map data including a plurality of points of interest (POIs) by a storing unit, and the POIs being divided into a plurality of ranks;
(S41) providing position data by a positioning unit;
(S42) obtaining the ranks and the quantity of the POIs around the position of the navigator according to the map data and the position data by a control unit;
(S43) determining whether the quantity of all POIs is higher than a quantity threshold value by the control unit;
If the quantity of all POIs is higher than a quantity threshold value, go to (S44);
(S44) determining whether the average rank of all POIs is higher than a rank threshold value by the control unit;
If the average rank of all POIs is higher than a rank threshold value, go to (S45); Otherwise, go to (S46);
(S45) controlling a display unit to enlarge the display range of the map adjacent to the position of the navigator by the control unit; and
(S46) controlling a display unit to maintain the display range of the map adjacent to the position of the navigator by the control unit.
Wherein, the step (S43) could be executed before the step (S44). The priority of execution is not restricted in the present invention.

The implementation of the device in accordance with the present invention has already described in the description of the embodiments of the navigator according to the present invention, so it will not be stated here again.

Described above are some preferred embodiments in accordance with the present invention. Other than the preferred embodiments, all units mentioned above could be applied through software, hardware unit of combination of above, and could accompany with firmware devices necessarily. The implementation of the present invention could be applied to a navigator. Besides, the implementation of the present invention could also be applied through storing media, and the storing media could be a CD-ROM, a hard disk, a flash disk or the like. The storing media is loaded with a code, and when a processing unit reads and executes the code, at least the steps of (S10)-(S46) could be accomplished. On the other hand, the implementation of the present invention could also be applied through a computer product. The computer product is loaded with a code, and when a processing unit reads and executes the code, the method of the aforementioned embodiments could be accomplished. Selectively, the computer product could be transmitted through internet or other ways.

In summary, the navigator of the present invention could adjust the display range of the map adjacent to the position of the navigator according to the ranks and the quantity of the POIs to avoid problem that the displayed frame too complicated to be easily understood by the user and to increase the clarity and the convenience when browsing.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A navigator, comprising:
a storing unit storing map data including a plurality of points of interest (POIs);
a positioning unit providing position data; and
a control unit electronically connecting to the storing unit and the positioning unit, and obtaining the quantity of the POIs around a position of the navigator according to the map data and the position data, and the control unit further controlling a display unit to adjust a display range of a map adjacent to the position of the navigator according to the quantity of the POIs and a quantity threshold value.

2. The navigator of claim 1, wherein the control unit controls the display unit to reduce the display range of the map adjacent to the position of the navigator when the quantity of the POI is higher than the quantity threshold value.

3. The navigator of claim 1, wherein the control unit controls the display unit to enlarge the display range of the map adjacent to the position of the navigator when the quantity of the POI is lower than the quantity threshold value.

4. A navigator, comprising:
a storing unit storing map data including a plurality of points of interest (POIs), the POIs being divided into a plurality of ranks;
a positioning unit providing position data; and
a control unit electronically connecting to the storing unit and the positioning unit, and obtaining the ranks of the POIs around a position of the navigator according to the map data and the position data, and the control unit further controlling a display unit to adjust a display range of a map adjacent to the position of the navigator according to the ranks of the POIs and a rank threshold value.

5. The navigator of claim 4, wherein the control unit controls the display unit to enlarge the display range of the map adjacent to the position of the navigator when the rank of the POI is higher than the rank threshold value.

6. The navigator of claim 4, wherein the control unit controls the display unit to reduce the display range of the map adjacent to the position of the navigator when the rank of the POI is lower than the rank threshold value.

7. A navigator, comprising:
a storing unit storing map data including a plurality of points of interest (POIs), the POIs being divided into a plurality of ranks;
a positioning unit providing position data; and
a control unit electronically connecting to the storing unit and the positioning unit, and obtaining the ranks and the quantity of the POIs around a position of the navigator according to the map data and the position data, and the control unit further controlling a display unit to adjust a display range of a map adjacent to the position of the navigator according to the ranks of the POIs, the quantity of the POIs, a quantity threshold value and a rank threshold value.

8. The navigator of claim 7, wherein the control unit controls the display unit to enlarge the display range of the map adjacent to the position of the navigator when the quantity of the POI is higher than the quantity threshold value and the rank of the POI is higher than the rank threshold value.

9. The navigator of claim 7, wherein the control unit controls the display unit to reduce the display range of the map adjacent to the position of the navigator when the quantity of the POI is higher than the quantity threshold value and he rank of the POI is lower than the rank threshold value.

10. The navigator of claim 7, wherein the control unit controls the display unit to enlarge the display range of the map adjacent to the position of the navigator when the quantity of the POI is lower than the quantity threshold value and the rank of the POI is higher than the rank threshold value.

11. The navigator of claim 7, wherein the control unit controls the display unit to maintain the display range of the map adjacent to the position of the navigator when the quantity of the POI is lower than the quantity threshold value and the rank of the POI is lower than the quantity threshold value.
